(19) United States
(12) Patent Application Publication
(10) Pub. No.: US 2004/0162864 A1
(43) Pub. Date: Aug. 19, 2004

(54) System and method for generating pseudo-random numbers

(75) Inventors: Farshid Nowshadi, Luton (GB); Mark Justin Moore, Cambridge (GB)

Correspondence Address: HUNTON & WILLIAMS LLP, INTELLECTUAL PROPERTY DEPARTMENT, 1900 K STREET, N.W., SUITE 1200, WASHINGTON, DC, 20006-1109, US

(73) Assignee: Globespan Virata Inc., Red Bank, NJ

(21) Appl. No.: 10/614,220

(22) Filed: Jul. 8, 2003

Related U.S. Application Data
(60) Provisional application No. 60/393,733, filed on Jul. 8, 2002.

(51) Int. Cl. G06F 1/02

(52) U.S. Cl. 708/254

(57) ABSTRACT

A method and system is provided for generating pseudo-random numbers utilizing techniques of both the SHA-1 and DES encryption standards, wherein a pseudo-random number generator is re-keyed periodically using an external input of physical randomness. In accordance with one embodiment of the present invention, a current seed value Sⱼ is loaded from a non-volatile storage. Next, values E, representative of environmental randomness, and C, representative of configuration data are likewise loaded. A new seed value, Sⱼ₊₁, is generated in accordance with the equation Sⱼ₊₁=f (Sⱼ; A; C; E), wherein f represents a selected encryption algorithm, and B is a second constant, and wherein Sⱼ is concatenated with A, which is concatenated with C which is concatenated with E. The new seed is then written to the non-volatile storage. Next, a key, K, is generated in accordance with the equation K=f (Sⱼ; B; C; E), wherein B is a second constant. Lastly, a pseudo-random number output, Pₙ, is generated in accordance with the equation Pₙ=f_{3DES}(K, Pₙ₋₁), where f_{3DES} represents the operation of triple DES encryption hardware, and Pₙ₋₁ is the previously generated pseudo-random number.

### CROSS-REFERENCE TO RELATED APPLICATIONS

The present applications claims priority to co-pending United States Provisional Patent Application No. 60/393,733 entitled “System and Method for Generating Pseudo-Random Numbers, filed on Jul. 8, 2003, the entirety of which is incorporated by reference herein.

### BACKGROUND OF THE INVENTION

The present invention relates generally to the field of computer systems and, more particularly, to systems and methods for generating random or pseudo-random numbers within such systems, for the purpose of maintaining system security.

Many chips have the means to generate random numbers. These may be true random number generators, in which the randomness comes from some physical source such as shot noise or oscillator drift; or pseudorandom number generators, in which a key is used to generate a long sequence of bits that are hard to predict if the key is not known. Each has its advantages.

True random number generators produce outputs that are statistically independent of each other. Thus the compromise of some set of outputs, or of the state of the device at some given time, does not impair the security of random numbers generated in either the past or the future. On the other hand, true random number generators are tricky to design (many designs being dependent on the precise fabrication process); they are hard to test; they may be vulnerable to an opponent who can manipulate chip inputs (such as Vcc); and the rate at which random numbers are generated is usually fairly low.

Pseudorandom number generators can provide deterministic output at high rates; they can use thoroughly studied and well-understood building blocks; and can be made just as testable and resilient as the rest of the device. However their unpredictability depends on some cryptographic key remaining unknown to an opponent. While appropriate use of a one-way cryptographic function can prevent a key compromise being used to deduce previous inputs, there is no obvious way to recover security following a compromise. Unfortunately, known methods for generating such pseudo-random numbers such as encryption using the SHA-1 or DES algorithms do not afford the level of protection required to ensure that the cryptographic key remains secure.

Accordingly, there is a need in the art of computer systems for a system and method for generating pseudo-random numbers which overcome the security limitations of known systems.

### SUMMARY OF THE INVENTION

The present invention overcomes the problems noted above, and realizes additional advantages, by providing for methods and systems for generating pseudo-random numbers utilizing techniques of both the SHA-1 and DES encryption standards.

In accordance with one embodiment of the present invention a current seed value Sⱼ is loaded from a non-volatile storage. Next, values E, representative of environmental randomness, and C, representative of configuration data are likewise loaded. A new seed value, Sⱼ₊₁, is generated in accordance with the equation Sⱼ₊₁=f (Sⱼ; A; C; E), wherein f represents a selected encryption algorithm, and B is a second constant, and wherein Sⱼ is concatenated with A, which is concatenated with C which is concatenated with E. The new seed is then written to the non-volatile storage. Next, a key, K, is generated in accordance with the equation K=f (Sⱼ; B; C; E), wherein B is a second constant. A pseudo-random number output, Pₙ, is then generated in accordance with the equation Pₙ=f_{3DES}(K, Pₙ₋₁), where f_{3DES} represents the operation of triple DES encryption hardware, and Pₙ₋₁ is the previously generated pseudo-random number.

### BRIEF DESCRIPTION OF THE DRAWINGS

The present invention can be understood more completely by reading the following Detailed Description of the Preferred Embodiments, in conjunction with the accompanying drawings.

FIG. 1 is a simplified flow diagram illustrating one embodiment of a method for generating pseudo-random numbers in accordance with the present invention.

### DETAILED DESCRIPTION OF THE INVENTION

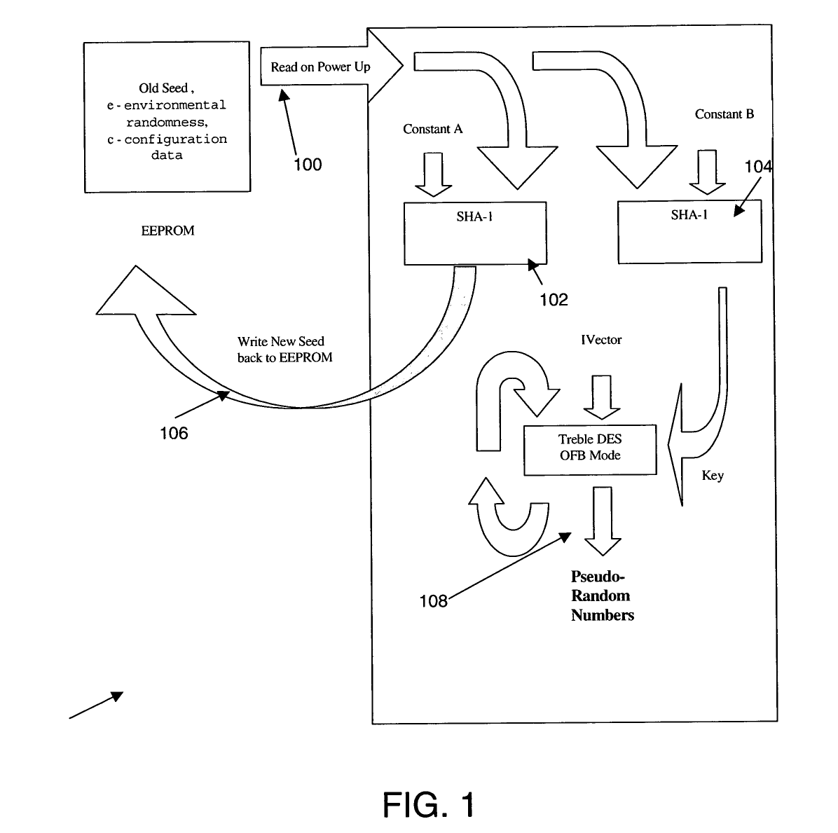

Referring now to the Figures and, in particular, to FIG. 1, there is shown a simplified flow diagram illustrating one embodiment of a method and system for generating pseudo-random numbers in accordance with the present invention. In particular, the present invention utilizes key features of both of the above-identified methodologies. This combination of the two approaches results in a pseudo-random number generator that is re-keyed periodically using an external input of physical randomness.

The pseudo-random number output will be computed in step 108 using the 3DES (triple DES) encryption hardware, operated in output feedback mode. Writing f_{3DES}(K, P) for the encryption of P using the key K, we have

Pₙ=f_{3DES} (K,Pₙ₋₁)

Where, the initial value P₀ can be set to any fixed value such as 0. This will provide a source of pseudorandom numbers with a rate of about 15 Mbit/sec. The key K will be derived from a seed S kept externally in non-volatile memory. Initially, on power-up, the device loads the current value Sⱼ of the seed, plus configuration data C and environmental randomness E in step 100. The device will compute the key K in step 102 and the next value Sⱼ₊₁ of the seed in step 104 as follows, using, in one embodiment, the FIPS 180 secure hash standard algorithm (SHA). The seed Sⱼ will preferably be 160 bits in length if the current secure hash standard algorithm SHA-1 is used, and 256 bits if the proposed new standard SHA-256 algorithm is used:

Sⱼ₊₁=f_{SHA} (Sⱼ; A; C; E)

K=f_{SHA} (Sⱼ; B; C; E)

Here A and B are two different fixed constants whose value is not otherwise critical (for example, A=1 and B=2). Furthermore, the phrase (X; Y) denotes X concatenated with Y. The configuration data C may be any length, and the environmental randomness E should have at least 80 bits of entropy.

Following this updating computation, the new seed value Sⱼ is written back to non-volatile storage in step 106. The function of the environmental randomness E (which may be derived from whatever sources are available) is security recovery. If, at some time, the seed is compromised by an adversary who manages to read the off-chip non-volatile storage, the use of fresh randomness should deny him knowledge of subsequent seeds and the pseudorandom numbers derived from them.

In an additional embodiment, if it is desired to make it harder for a competitor to produce a compatible chip, then one or more of the components of the updating computation may be protected. A simple way to do this is to make A and B into secrets that are read from a ROM address that is not externally readable. A more thorough way to obscure the computation is to replace SHA with an algorithm that is proprietary. In the former case, A and B may be compromised by an opponent who mounts an invasive attack (such as microprobing the bus, or using a scanning capacitance microscope to read out the ROM). In the latter case, an opponent who performs this reverse engineering is further hindered by proprietary algorithm. If the threat of litigation is reckoned to be enough in itself, then, the constants A and B might contain as substrings the customer's copyright notice.

Further, if it is desired that a key compromised occurring during a session should not expose keys used earlier in that session, then the second equation of the key updating computation may be carried out more frequently than once per power cycle. In the limit, all the random numbers could be computed using SHA as successive values of the key K. In this case, as no use would be made of the 3DES hardware provided, there would be a noticeable performance penalty. Whether this mattered would depend on the application.

If it becomes a requirement at some future time to have a true random source on-chip, then this can be input to an on-the-fly update. Some care is needed though to ensure that enough random bits are input to each update that an opponent cannot work forwards by exhaustive search.

It should be understood that the 160-bit SHA-1 algorithm is in the process of being supplemented by the 256-bit SHA-256 and the 512-bit SHA-512 algorithms. Similarly, the existing standard DES modes of operation are in the process of being supplemented by the new dual counter mode. The practical consequences of these upgrades for technical security are few, but it may be decided to support them anyway in case they become a checkbox item for customers. For example, it might be objected that the output of SHA is only 160 bits, while 3DES uses a 168-bit key. In practice, the remaining eight key bits may be set to an arbitrary or zero value; but the objection is removed by the use of SHA-256 from whose output 168 distinct key bits may be drawn. Similarly, it may be objected that 3DES in output feedback mode will cycle after about 2³² pseudorandom values have been drawn; this is unlikely to be an issue in the envisaged applications, but the objection is removed by the use of the new dual-counter mode of operation, for which a further 64 bits of key is required to initialize the counters. In that case, one should use SHA-256 to provide the 232 bits required in total.

The pseudo-random number generation system of the present invention makes a number of assumptions about the physical protection of the equipment being protected. In particular, the present invention assumes that the protected device contains no on-chip non-volatile memory, thus requiring that any encryption key material must be stored off-chip. It follows that potential adversaries must not have unsupervised access to the equipment. In particular, the off-chip non-volatile memory is to be kept secure & inaccessible by unauthorised personnel. Further, it is assumed that the attacker does not have unsupervised access to the electrical interface of the device or of associated chips, with which timing attacks might be possible.

While the foregoing description includes many details and specifities, it is to be understood that these have been included for the purposes of explanation only, and are not to be interpreted as limitations of the present invention. Many modifications to the embodiments described above can be made without departing from the spirit and scope of the invention, as is intended.

What is claimed is:

1. A method for generating pseudo-random numbers, comprising the steps of:
loading a current seed value Sⱼ from a non-volatile storage;
loading a value, E, representative of environmental randomness;
loading a value, C, representative of configuration data;
generating a new seed value, Sⱼ₊₁, in accordance with the following equation:
Sⱼ₊₁=f (Sⱼ; A; C; E),
wherein f represents a selected encryption algorithm, and B is a second constant, and wherein Sⱼ is concatenated with A, which is concatenated with C which is concatenated with E;
writing the new seed value Sⱼ₊₁ to the non-volatile storage;
generating a key, K, in accordance with the following equation:
K=f (Sⱼ;B;C;E),
wherein B is a second constant; and
generating a pseudo-random number output, Pₙ, in accordance with the following equation:
Pₙ=f_{3DES}(K, Pₙ₋₁),
where f_{3DES} represents the operation of triple DES encryption hardware, and Pₙ₋₁ is the previously generated pseudo-random number.

2. The method of claim 1, wherein the function f comprises the FIPS 180 secure hash standard algorithm (SHA).

3. The method of claim 1, wherein the value E includes at least 80 bits of entropy.

4. The method of claim 1, wherein the seed Sⱼ is 160 bits in length.

5. The method of claim 1, wherein the seed Sⱼ is 256 bits in length.

6. The method of claim 1, wherein the seed Sⱼ is 512 bits in length.

7. The method of claim 1, wherein an initial value of P₀ is 0.

8. The method of claim 1, further comprising the steps of loading values for the first and second constants A and B from a protected ROM address.

9. The method of claim 8, wherein the first and second constants A and B further incorporate a copyright notice embedded therein.

10. The method of claim 1, wherein the f_{3DES} hardware is operated in output feedback mode.

11. The method of claim 1, wherein the f_{3DES} hardware is operated in dual counter mode.

12. A computer-readable medium incorporating one or more instructions for generating pseudo-random numbers, the instructions comprising:
one or more instructions for loading a current seed value Sⱼ from a non-volatile storage;
one or more instructions for loading a value, E, representative of environmental randomness;
one or more instructions for loading a value, C, representative of configuration data;
one or more instructions for generating a new seed value, Sⱼ₊₁, in accordance with the following equation:
Sⱼ₊₁=f (Sⱼ; A; C; E),
wherein f represents a selected encryption algorithm, and B is a second constant, and wherein Sⱼ is concatenated with A, which is concatenated with C which is concatenated with E;
one or more instructions for writing the new seed value Sⱼ₊₁ to the non-volatile storage;
one or more instructions for generating a key, K, in accordance with the following equation:
K=f (Sⱼ; B; C; E),
wherein B is a second constant; and
one or more instructions for generating a pseudo-random number output, Pₙ, in accordance with the following equation:
Pₙ=f_{3DES}(K, Pₙ₋₁),
wherein f_{3DES} represents the operation of triple DES encryption hardware, and Pₙ₋₁ is the previously generated pseudo-random number.

13. The computer-readable medium of claim 12, wherein the function f comprises the FIPS 180 secure hash standard algorithm (SHA).

14. The computer-readable medium of claim 12, wherein the value E includes at least 80 bits of entropy.

15. The computer-readable medium of claim 12, wherein the seed Sⱼ is 160 bits in length.

16. The computer-readable medium of claim 12, wherein the seed Sⱼ is 256 bits in length.

17. The computer-readable medium of claim 12, wherein the seed Sⱼ is 512 bits in length.

18. The computer-readable medium of claim 12, wherein an initial value of P₀ is 0.

19. The computer-readable medium of claim 12, further comprising one or more instructions for loading values for the first and second constants A and B from a protected ROM address.

20. The computer-readable medium of claim 19, wherein the first and second constants A and B further incorporate a copyright notice embedded therein.

21. The computer-readable medium of claim 12, wherein the f_{3DES} hardware is operated in output feedback mode.

22. The computer-readable medium of claim 12, wherein the f_{3DES} hardware is operated in dual counter mode.
